(19) United States
(12) Patent Application Publication
(10) Pub. No.: US 2024/0094367 A1
(43) Pub. Date: Mar. 21, 2024

(54) DRIVE DEVICE AND ULTRASONIC SENSOR

(71) Applicant: ROHM CO., LTD., Kyoto (JP)

(72) Inventors: Takashi NAGAI, Kyoto (JP); Ken HASHIMOTO, Kyoto (JP)

(21) Appl. No.: 18/523,183

(22) Filed: Nov. 29, 2023

Related U.S. Application Data
(63) Continuation of application No. PCT/JP22/22068, filed on May 31, 2022.

(30) Foreign Application Priority Data
Jun. 3, 2021 (JP) 2021-093704
Dec. 28, 2021 (JP) 2021-215158

(51) Int. Cl. G01S 7/524; G01S 15/10; H02M 3/07

(52) U.S. Cl. CPC G01S 7/524; G01S 15/10; H02M 3/07

(57) ABSTRACT

A drive device includes a power supply circuit that includes a switch element, and a drive circuit that is configured to use a voltage supplied from the power supply circuit as a power supply voltage and that is configured to perform pulse driving of a drive-target element. The power supply circuit is configured to operate such that a switching frequency of the switch element differs from a frequency of the pulse driving.

### CROSS-REFERENCE TO RELATED APPLICATIONS

This nonprovisional application is a continuation application of International Patent Application No. PCT/JP2022/022068 filed on May 31, 2022, which claims priority Japanese Patent Application No. 2021-093704 filed in Japan on Jun. 3, 2021 and Japanese Patent Application No. 2021-215158 filed in Japan on Dec. 28, 2021, the entire contents of which are hereby incorporated by reference.

### BACKGROUND OF THE INVENTION

### 1. Technical Field

The invention disclosed herein relates to a drive device that drives a drive-target element, and an ultrasonic sensor that includes the drive device.

### 2. Description of Related Art

For example, Japanese Unexamined Patent Application Publication No. 2018-96752 discloses an ultrasonic sensor that includes a drive circuit that drives a piezoelectric element (a transmission unit that uses the piezoelectric element to transmit an output signal in an ultrasonic range). The drive circuit operates by using a voltage supplied from a power supply circuit as a power supply voltage.

### BRIEF DESCRIPTION OF THE DRAWINGS

FIG. 1 is a diagram showing a schematic configuration of an ultrasonic sensor according to a first comparative example.

FIG. 2 is a diagram showing waveforms of various voltages of the ultrasonic sensor according to the first comparative example.

FIG. 3 is a diagram showing a schematic configuration of an ultrasonic sensor according to a second comparative example.

FIG. 4 is a diagram showing a schematic configuration of an ultrasonic sensor according to a first embodiment.

FIG. 5 is a diagram showing waveforms of various voltages of the ultrasonic sensor according to the first embodiment.

FIG. 6 is a diagram showing a schematic configuration of an ultrasonic sensor according to a second embodiment.

FIG. 7 is a diagram showing waveforms of various voltages of the ultrasonic sensor according to the second embodiment.

FIG. 8 is a diagram showing an example of a frequency of switching noise of a power supply circuit.

FIG. 9 is a diagram showing examples of signal strength of a drive signal and signal strength of the switching noise of the power supply circuit.

FIG. 10 is an external view of a vehicle.

FIG. 11 is a diagram showing waveforms of various voltages of the ultrasonic sensor according to a modified example of the first embodiment in a second mode.

### DETAILED DESCRIPTION

Herein, a constant voltage denotes a voltage that is constant under ideal conditions, and may actually be a voltage that can vary slightly with change in temperature and the like.

Herein, a reference voltage denotes a voltage that is constant under ideal conditions, and may actually be a voltage that can vary slightly with change in temperature and the like.

### 1. Comparative Example

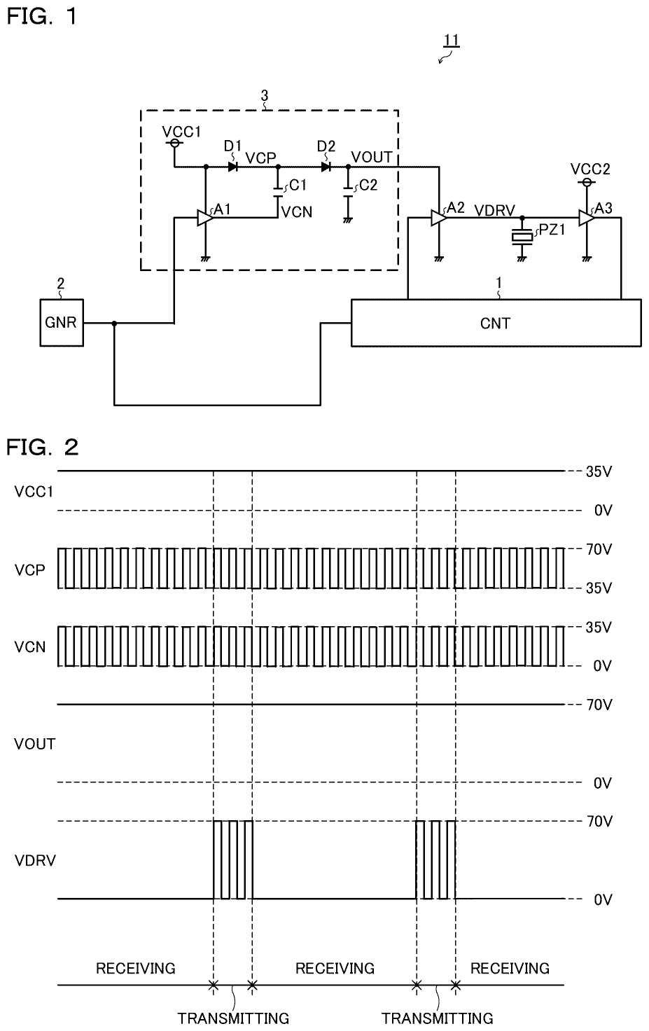

FIG. 1 is a diagram showing a schematic configuration of an ultrasonic sensor according to a first comparative example. An ultrasonic sensor 11 shown in FIG. 1 includes a control circuit 1, a clock signal generator 2, a power supply circuit 3, a drive circuit A2, a piezoelectric element PZ1, and a receiver circuit A3. The ultrasonic sensor 11 senses a distance to a measurement target.

The control circuit 1 controls the drive circuit A2 based on a clock signal output from the clock signal generator 2. The control circuit 1 processes an output signal of the receiver circuit A3, and calculates the distance to the measurement target.

The clock signal generator 2 generates the clock signal with a predetermined frequency.

The power supply circuit 3 performs switching of a switch element based on the clock signal output from the clock signal generator 2 to thereby generate an output voltage VOUT.

The power supply circuit 3 is a charge pump circuit that includes an amplifier A1 that amplifies the clock signal, a diode D1 that is a switch element, a flying capacitor C1, a diode D2, and a capacitor C2. The clock signal is supplied to an input end of the amplifier A1. An output end of the amplifier A1 is connected to a negative pole of the flying capacitor C1.

A first constant voltage VCC1 is applied to an anode of the diode D1 and a power supply end of the amplifier A1. A ground end of the amplifier A1 is connected to a ground potential.

A cathode of the diode D1 is connected to a positive pole of the flying capacitor C1 and an anode of the diode D2. A cathode of the diode D2 is connected to a positive pole of the capacitor C2. A negative pole of the capacitor C2 is connected to the ground potential. A voltage at the positive pole of the capacitor C2 becomes the output voltage VOUT of the power supply circuit 3.

The drive circuit A2, which uses a voltage supplied from the power supply circuit 3 as a power supply voltage, is configured to perform pulse driving of the piezoelectric element PZ1. Specifically, the drive circuit A2 is an amplifier that amplifies a control signal output from the control circuit 1. The control circuit 1 outputs a plurality of pulse signals as the control signal during a transmitting operation of the ultrasonic sensor 11, and outputs a signal fixed to LOW level as the control signal during a receiving operation of the ultrasonic sensor 11. The drive circuit A2 vibrates the piezoelectric element PZ1 in an ultrasonic range.

The control signal output from the control circuit 1 is supplied to an input end of the drive circuit A2. An output end of the drive circuit A2 is connected to a first end of the piezoelectric element PZ1 and an input end of the receiver circuit A3. The output voltage VOUT of the power supply circuit 3 is applied to a power supply end of the drive circuit A2. A ground end of the drive circuit A2 and a second end of the piezoelectric element PZ1 are connected to the ground potential.

The receiver circuit A3, which uses a second constant voltage VCC2 as a power supply voltage, receives an output signal of the piezoelectric element PZ1. Specifically, the receiver circuit A3 is an amplifier that amplifies the output signal of the piezoelectric element PZ1. The output signal of the piezoelectric element PZ1 is supplied to the input end of the receiver circuit A3. The output signal of the receiver circuit A3 is supplied to the control circuit 1. The second constant voltage VCC2 is applied to a power supply end of the receiver circuit A3. A ground end of the receiver circuit A3 is connected to the ground potential.

FIG. 2 is a diagram showing waveforms of various voltages of the ultrasonic sensor 11. Specifically, FIG. 2 is a diagram showing waveforms of the first constant voltage VCC1, a positive-pole voltage VCP of the flying capacitor C1, a negative-pole voltage VCN of the flying capacitor C1, the output voltage VOUT of the power supply circuit 3, and a drive voltage VDRV output from the drive circuit A2. Note that the values 35V and 70V indicated in FIG. 2 are merely examples, and other values may be used instead.

When the clock signal is at LOW level, the diode D1 is turned on to charge the flying capacitor C1, and when the positive-pole voltage VCP of the flying capacitor C1 reaches 35 V, the diode D1 is turned off. Then, when the clock signal is turned from LOW level to HIGH level, the diode D1 remains OFF, the negative-pole voltage VCN of the flying capacitor C1 rises to 35 V, the positive-pole voltage VCP of the flying capacitor C1 rises to 70V, and the flying capacitor C1 discharges.

### 2. Second Comparative Example

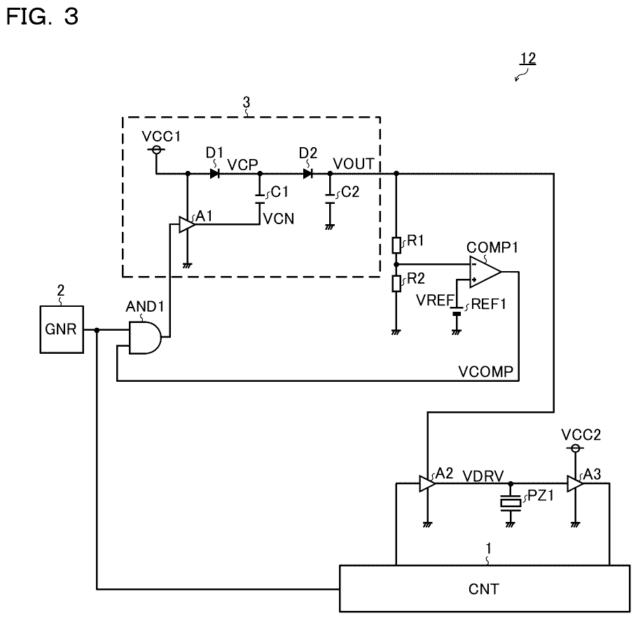

The ultrasonic sensor 11 is disadvantageous in that the output voltage of the power supply circuit 3 cannot be controlled to a desired value due to the dependence of the output voltage of the power supply circuit 3 on the first constant voltage VCC1. An ultrasonic sensor according to a second comparative example is an ultrasonic sensor that is capable of eliminating the disadvantage. FIG. 3 is a diagram showing a schematic configuration of the ultrasonic sensor according to the second comparative example.

An ultrasonic sensor 12 shown in FIG. 3 has a configuration obtained by additionally providing the ultrasonic sensor 11 shown in FIG. 1 with resistors R1 and R2, a comparator COMP1, a reference voltage supply REF1, and an AND gate AND1. The ultrasonic sensor 12 also senses a distance to a measurement target similarly to the ultrasonic sensor 11.

A first end of the resistor R1 is connected to the positive pole of the capacitor C2. A second end of the resistor R1 and a first end of the resistor R2 are connected to an inverting input end of the comparator COMP1. A positive pole of the reference voltage supply REF1 is connected to a non-inverting input end of the comparator COMM. A second end of the resistor R2 and a negative pole of the reference voltage supply REF1 are connected to the ground potential. The clock signal output from the clock signal generator 2 is supplied not to the input end of the amplifier A1, but to a first input end of the AND gate AND1. An output signal VCOMP of the comparator COMP1 is supplied to a second input end of the AND gate AND1. An output end of the AND gate AND1 is connected to the input end of the amplifier A1.

The resistors R1 and R2 divides the output voltage VOUT of the power supply circuit 3. In a case where a divided voltage of the output voltage VOUT of the power supply circuit 3 is lower than a reference voltage VREF output from the reference voltage supply REF1, the power supply circuit 3 performs a switching operation of the diode D1. On the other hand, in a case where the divided voltage of the output voltage VOUT of the power supply circuit 3 is higher than the reference voltage VREF output from the reference voltage supply REF1, the power supply circuit 3 does not perform the switching operation of the diode D1. In this manner, it is possible to control the output voltage of the power supply circuit 3 to a desired value.

### 3. First Embodiment

In the ultrasonic sensor 12, a length of a time period during which the power supply circuit 3 does not perform the switching operation of the diode D1 is determined depending on a load current value, capability of the power supply circuit 3, a value of the first constant voltage VCC1, etc. Thus, it is impossible to control the period of the time period during which the power supply circuit 3 performs the switching operation of the diode D1 and the time period during which the power supply circuit 3 does not perform the switching operation of the diode D1. Consequently, in the ultrasonic sensor 12, there is a risk that the reciprocal of the period of the time period during which the power supply circuit 3 performs the switching operation of the diode D1 and the time period during which the power supply circuit 3 does not perform the switching operation of the diode D1 may coincide with the frequency of the pulse driving of the drive circuit A2. That is, there is a risk that, in the ultrasonic sensor 12, the frequency of the switching noise of the power supply circuit 3 and the frequency of the pulse driving of the drive circuit A2 may coincide with each other.

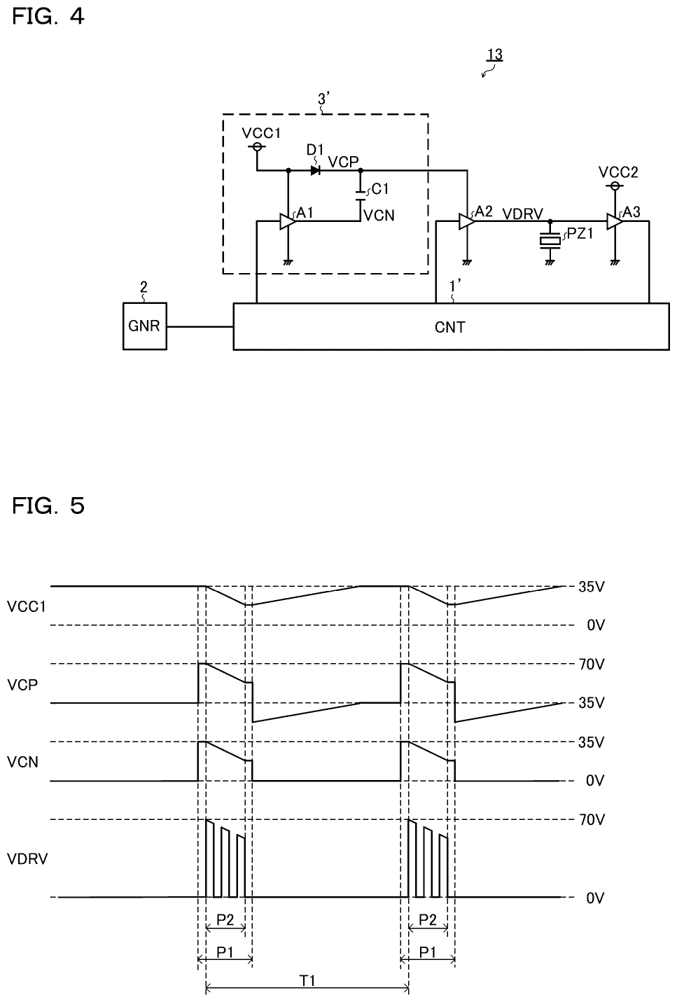

An ultrasonic sensor according to the first embodiment is one in which the frequency of switching noise of the power supply circuit and the frequency of the pulse driving of the drive circuit do not coincide with each other. FIG. 4 is a diagram showing a schematic configuration of the ultrasonic sensor according to the first embodiment.

An ultrasonic sensor 13 shown in FIG. 4 has a configuration obtained by replacing, in the ultrasonic sensor 11 shown in FIG. 1, the control circuit 1 and the power supply circuit 3 respectively with a control circuit 1′ and a power supply circuit 3′. The ultrasonic sensor 13 also senses a distance to a measurement target similarly to the ultrasonic sensors 11 and 12.

The control circuit 1′ controls the drive circuit A2 based on the clock signal output from the clock signal generator 2. The control circuit 1′ processes the output signal of the receiver circuit A3, and calculates the distance to the measurement target.

The control circuit 1′ supplies a signal for controlling the power supply circuit 3′ to the input end of the amplifier A1.

The power supply circuit 3′ has a configuration obtained by removing a smoothing circuit constituted of the diode D2 and the capacitor C2 from the power supply circuit 3. That is, the power supply circuit 3′ has a configuration that does not include a smoothing circuit. The power supply circuit 3′, in comparison with the power supply circuit 3, can be composed of fewer components. Consequently, the power supply circuit 3′ can be made compact and low-cost.

The power supply circuit 3′ supplies the positive-pole voltage VCP of the flying capacitor C1 to the power supply end of the drive circuit A2.

The power supply circuit 3′ is configured to operate, based on the signal fed from the control circuit 1′, such that the frequency of the switching of the diode D1 and the frequency of the pulse driving of the drive circuit A2 differ from each other. In this manner, it is possible to prevent the signal processing of the piezoelectric element PZ1 from being negatively affected by the switching noise of the power supply circuit 3′.

Specifically, the power supply circuit 3′ is configured to operate such that the pulse driving of the drive circuit A2 is started after the discharge of the flying capacitor C1 is started, and the discharge of the flying capacitor C1 is ended after the pulse driving of the drive circuit A2 is ended. That is, the power supply circuit 3′ performs the discharge of the flying capacitor C1 only when the pulse driving of the drive circuit A2 is required. In this manner, it is possible to prevent the power supply circuit 3′ from unnecessarily performing the switching operation. Further, such restriction on the discharge time period makes it possible for the power supply circuit 3′ not to include the smoothing circuit described above.

FIG. 5 is a diagram showing waveforms of various voltages of the ultrasonic sensor 13. Specifically, FIG. 5 is a diagram showing waveforms of the first constant voltage VCC1, the positive-pole voltage VCP of the flying capacitor C1, the negative-pole voltage VCN of the flying capacitor C1, and the drive voltage VDRV output from the drive circuit A2. Note that the values 35 V and 70 V indicated in FIG. 5 are merely examples, and other values may be used instead.

It is preferable that a length of a first time period P1 from start to end of the discharge of the flying capacitor C1 be equal to or longer than a length of a second time period P2 from start to end of the pulse driving of the drive circuit A2 but equal to or shorter than two times the length of the second time period P2. This is because, if the length of the first time period P1 is longer than two times the length of the second time period P2, there is a risk that, during the pulse driving of the drive circuit A2, the positive-pole voltage VCP of the flying capacitor C1 may fall below an acceptable value. However, the length of the first time period P1 does not necessarily need to be equal to or shorter than two times the length of the second time period P2, and a design is possible where, for example, the length of the first time period P1 is equal to 10 times the length of the second time period P2.

Note that, in the present embodiment, the driving method of the drive circuit A2 is a single-ended driving method, but the driving method of the drive circuit A2 may be, for example, a differential driving method. Further, the power supply circuit 3′ may have a configuration other than the one shown in FIG. 4 as long as it is a charge pump circuit.

### 4. Second Embodiment

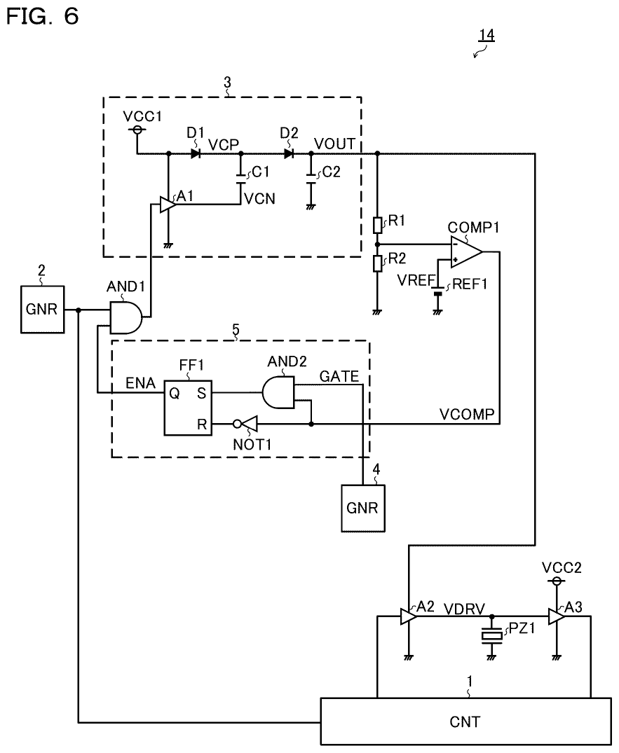

An ultrasonic sensor according to a second embodiment is, similarly to the ultrasonic sensor 13 shown in FIG. 4, an ultrasonic sensor in which the frequency of the switching noise of the power supply circuit and the frequency of the pulse driving of the drive circuit do not coincide with each other. FIG. 6 is a diagram showing a schematic configuration of the ultrasonic sensor according to the second embodiment.

An ultrasonic sensor 14 shown in FIG. 6 has a configuration obtained by additionally providing the ultrasonic sensor 12 shown in FIG. 3 with a clock signal generator 4 that generates a guard-band clock signal GATE, an AND gate AND2, a NOT gate NOT1, and an SR flip-flop FF1. The ultrasonic sensor 14 senses a distance to a measurement target similarly to the ultrasonic sensors 11 to 13.

The guard-band clock signal GATE generated by the clock signal generator 4 is connected to a first input end of the AND gate AND2. The guard-band clock signal GATE makes it easy to set permission time periods, which will be described later.

The output signal VCOMP of the comparator COMP1 is connected not to the second input end of the AND gate AND1 but to an input end of the NOT gate NOT1 and a second input end of the AND gate AND2.

An output end of the AND gate AND2 is connected to a set end of the SR flip-flop FF1. An output end of the NOT gate NOT1 is connected to a reset end of the SR flip-flop FF1. An output end of the SR flip-flop FF1 is connected to the second input end of the AND gate AND1.

The AND gate AND2, the NOT gate NOT1, and the SR flip-flop FF1 constitute a control circuit 5. The control circuit 5 is a control circuit having a simple circuit configuration that includes a latch circuit and a plurality of logic gates. The control circuit 5 is configured to permit the switching operation of the diode D1 to be started only during permission time periods set with a fixed period. Specifically, the control circuit 5 is configured to permit the switching operation of the diode D1 to be started only during a time period in which the guard-band clock signal GATE is at HIGH level.

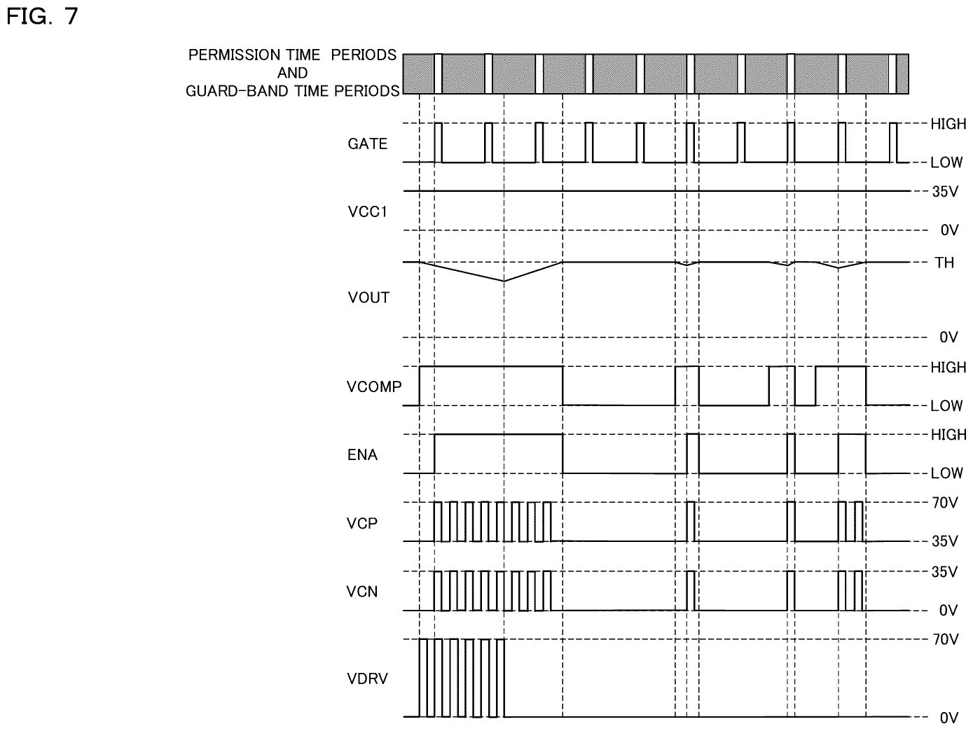

In a time period during which the guard-band clock signal GATE is at HIGH level, when the divided voltage of the output voltage VOUT of the power supply circuit 3 becomes lower than the reference voltage VREF output from the reference voltage supply REF1 (that is, when the output voltage VOUT becomes lower than a later-described threshold value TH indicated in FIG. 7), the switching operation of the diode D1 is started. In this manner, it is possible to control the length of a time period during which the power supply circuit 3 does not perform the switching operation of the diode D1, and thus to prevent the signal processing of the piezoelectric element PZ1 from being negatively affected by the switching noise of the power supply circuit 3.

The control circuit 5 is configured to give permission both in the permission time periods described above and in guard-band time periods each provided adjacent ones of the permission time periods. That is, the control circuit 5 is configured to always permit the switching operation of the diode D1 to be ended. In this manner, it is possible to suppress excessive switching operation of the switch element.

FIG. 7 is a diagram showing waveforms of various voltages of the ultrasonic sensor 14. Specifically, FIG. 7 shows waveforms of the guard-band clock signal GATE, the first constant voltage VCC1, the output voltage VOUT of the power supply circuit 3, the output signal VCOMP of the comparator COMP1, an output signal ENA of the SR flip-flop FF1, the positive-pole voltage VCP of the flying capacitor C1, the negative-pole voltage VCN of the flying capacitor C1, and the drive voltage VDRV output from the drive circuit A2. In FIG. 7, shaded parts each indicate a guard-band time period, and white parts between the shaded parts each indicate a permission time period.

Note that the values 35 V and 70 V indicated in FIG. 7 are merely examples, and other values may be used instead. Further, in FIG. 7, for convenience' sake, the frequencies of the positive-pole voltage VCP of the flying capacitor C1 and the negative-pole voltage VCN of the flying capacitor C1 are illustrated identical the frequency of the pulse driving of the drive circuit A2 in a time period during which the switching operation of the diode D1 is performed, but are normally greatly different from the frequency of the pulse driving. For example, in a time period during which the switching operation of the diode D1 is performed, the frequencies of the positive-pole voltage VCP of the flying capacitor C1 and the negative-pole voltage VCN of the flying capacitor C1 are each set to 10 MHz, while the frequency of the pulse driving of the drive circuit A2 is set to 58 kHz.

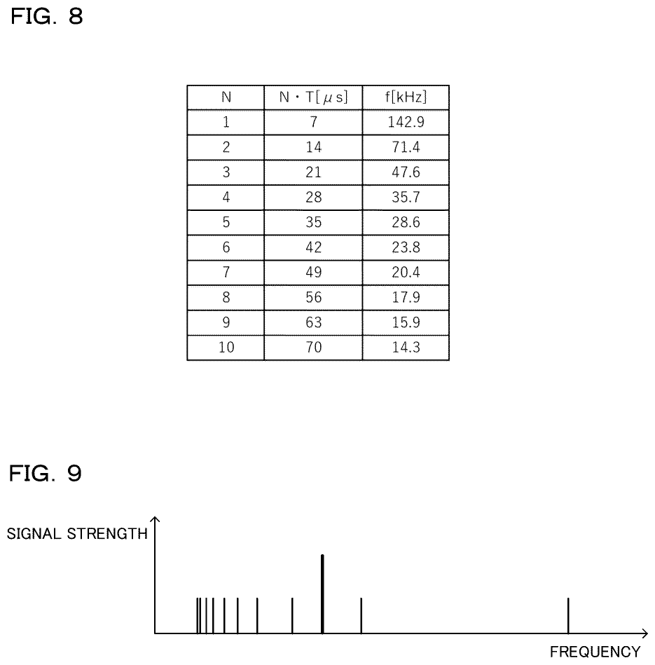

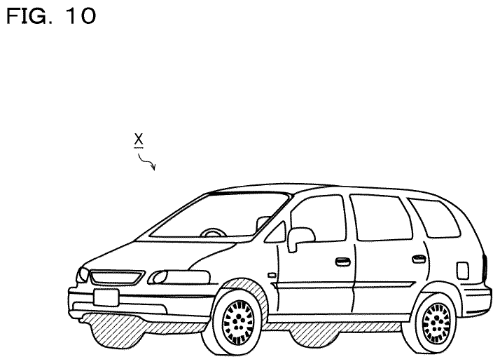

In the case where the frequency of the pulse driving of the drive circuit A2 is set to 58 kHz, the fixed period of the permission time periods may be set to 7 μs as shown in FIG. 8. By thus setting the fixed period of the permission time periods, it is possible, as shown in FIG. 9, to make the frequency of the pulse driving of the drive circuit A2 and the frequency of the switching noise of the power supply circuit 3 different from each other. Here, in FIG. 9, the horizontal axis represents frequency, and the vertical axis represents signal strength.

Note that, in the present embodiment, the driving method of the drive circuit A2 is a single-ended driving method, but the driving method of the drive circuit A2 may be, for example, a differential driving method. Further, the power supply circuit 3 is not limited to a charge pump circuit, but may be a switching power supply, for example.

### 5. Application Example

The ultrasonic sensors described above are each usable as a vehicle-mounted clearance sonar to be mounted on a vehicle X shown in FIG. 10, for example. Further, the drive device that drives the piezoelectric element can be mounted on an ultrasonic flowmeter that measures the velocity of a fluid, for example, other than an ultrasonic sensor that senses the distance to a measurement target.

Note that the drive-target element to be driven by the drive device is not limited to a piezoelectric element.

### 6. Others

Note that the present invention can be implemented with any other configuration than those of the embodiments described above, with various modifications made without departure from the spirit of the present invention. It should be understood that the foregoing embodiments are not limitative but illustrative in every respect. The technical scope of the present invention is not determined by the foregoing embodiments but by the claims, and should be construed to include all modifications equivalent in meaning and scope to the claims.

For example, in the second embodiment, the comparator COMP1 may be a hysteresis comparator.

Further, in each of the above-described embodiments, the power supply circuit is configured to always perform a step-up operation; however, unlike in the above-described embodiments, the drive device that drives the piezoelectric element PZ1 may have a first mode in which the step-up operation of the power supply circuit is turned on and a second mode in which the step-up operation of the power supply circuit is turned off.

Now, a modified example of the first embodiment will be described. An ultrasonic sensor according to the modified example of the first embodiment is similar, in schematic configuration, to the ultrasonic sensor according to the first embodiment shown in FIG. 4.

However, in the ultrasonic sensor according to the modified example of the first embodiment, the output of the amplifier A1 is held at 0 V in the second mode. As a result, in the ultrasonic sensor according to the modified example of the first embodiment, in the second mode, the step-up operation of the power supply circuit 3 is turned off.

Examples of the configuration in which the output of the amplifier A1 is held at 0 V in the second mode include, for example, a configuration in which, in the second mode, supply of the clock signal to the amplifier A1 is stopped, a configuration in which, in the second mode, the amplifier A1 outputs a voltage of 0 V regardless of inputs, etc.

Waveforms of various voltages in the first mode of the ultrasonic sensor according to the modified example of the first embodiment are similar to the waveforms of the various voltages of the ultrasonic sensor according to the first embodiment shown in FIG. 5.

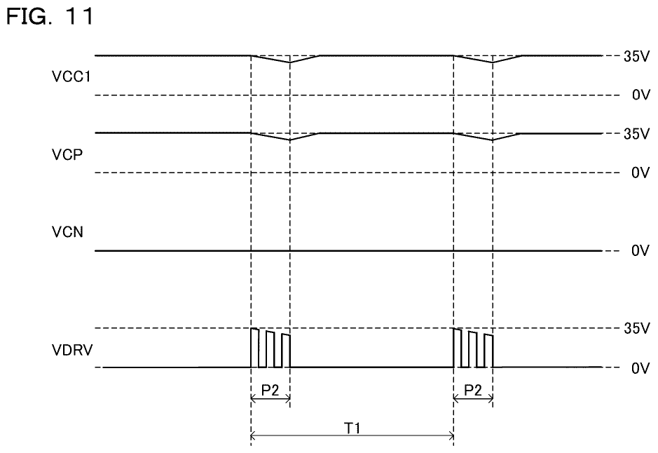

A diagram illustrating the waveforms of the ultrasonic sensor according to the modified example of the first embodiment in the second mode is as shown in FIG. 11.

In the first mode, the drive voltage VDRV becomes high, and thus the piezoelectric element PZ1 can be driven strongly. Consequently, in the first mode, even if a measurement target is located far from the ultrasonic sensor according to the modified example of the first embodiment, it is possible to measure the distance between the measurement target and the ultrasonic sensor according to the modified example of the first embodiment.

However, in the first mode, since the power supply circuit 3 performs the step-up operation, the first constant voltage VCC1 drops greatly after an end of the stepping-up of the positive-pole voltage VCP of the flying capacitor C1, and as a result, it takes time to step up the positive-pole voltage VCP of the flying capacitor C1 again. Further, in the first mode, the drive voltage VDRV is high, and thus there is a long reverberation time after the piezoelectric element PZ1 is driven. That is, in the first mode, in a case where a measurement target is located close to the ultrasonic sensor according to the modified example of the first embodiment, it is difficult to measure the distance between the measurement target and the ultrasonic sensor according to the modified example of the first embodiment.

On the other hand, in the second mode, the power supply circuit 3 does not perform the step-up operation, and thus there is no need to secure a waiting time until stepping up of the positive-pole voltage VCP of the flying capacitor C1 again is completed. Further, in the second mode, the drive voltage VDRV is low, and thus there is a short reverberation time after the piezoelectric element PZ1 is driven. Consequently, in the second mode, even in a case where a measurement target is located near the ultrasonic sensor according to the modified example of the first embodiment, it is easy to measure the distance between the measurement target and the ultrasonic sensor according to the modified example of the first embodiment.

The ultrasonic sensor according to the modified example of the first embodiment is capable of dealing with both a situation where it is suitable to strongly drive the piezoelectric element PZ1 (e.g., a situation that requires long-distance measurement) and a situation where it is suitable to weakly drive the piezoelectric element PZ1 (e.g., a situation that requires short-distance measurement).

The ultrasonic sensor according to the modified example of the first embodiment, which intermittently repeats the pulse driving of the piezoelectric element PZ1, executes the first mode when a period T1 (see FIG. 5 and FIG. 11) of the repetition is set to be equal to or longer than a threshold value (e.g., 10 ms), and executes the second mode when the period T1 of the repetition is set to be shorter than the threshold value (e.g., 10 ms).

The ultrasonic sensor according to the modified example of the first embodiment can drive the piezoelectric element PZ1 strongly and periodically with low frequency by executing the first mode, and can drive the piezoelectric element PZ1 weakly and periodically with high frequency by executing the second mode. Consequently, the ultrasonic sensor according to the modified example of the first embodiment is capable of dealing with both a situation where it is suitable to drive the piezoelectric element PZ1 strongly and periodically with low frequency (e.g., a situation that requires long-distance measurement in which it is necessary to take a long time period for receiving a reflected wave) and a situation where it is suitable to drive the piezoelectric element PZ1 weakly and periodically with high frequency (e.g., a situation that requires short-distance measurement in which it is desirable, in terms of collision avoidance, to frequently confirm the position of a measurement target.

In the embodiments and the modified example described above, so long as an extent to which the signal processing of the drive-target element is affected by the switching noise of the power supply circuit is within a permissible range, the switching frequency of the switch element and the frequency of the pulse driving of the drive-target element may be the same.

A drive device described above includes a power supply circuit (3′) that includes a switch element (D1), and a drive circuit (A2) that is configured to use a voltage supplied from the power supply circuit as a power supply voltage and that is configured to perform pulse driving of the drive-target element, and the power supply circuit is configured to operate such that a switching frequency of the switch element differs from a frequency of the pulse driving (a first configuration).

The drive device having the above first configuration is capable of preventing signal processing of the drive-target element from being negatively affected by switching noise of the power supply circuit.

In the drive circuit having the above first configuration, the power supply circuit may be a charge pump circuit that includes a flying capacitor (C1), and the power supply circuit may be configured to operate such that the pulse driving is started after discharge of the flying capacitor is started, and such that the discharge of the flying capacitor is ended after the pulse driving is ended (a second configuration).

In the drive device having the above second configuration, the power supply circuit performs the discharge of the flying capacitor only when the pulse driving of the drive circuit is required. This helps prevent the power supply circuit from unnecessarily performing the switching operation.

In the drive device having the above second configuration, a length of a first time period from start to end of the discharge of the flying capacitor may be equal to or longer than a length of a second time period from start to end of the pulse driving but equal to or shorter than two times the length of the second time period (a third configuration).

The drive device having the above third configuration is capable of avoiding fall of a positive-pole voltage of the flying capacitor below an acceptable value during the pulse driving of the drive circuit.

In the drive device having the above second or third configuration, the power supply circuit may be configured not to include a smoothing circuit in an output stage of the power supply circuit (a fourth configuration).

In the drive device having the above fourth configuration, the power supply circuit can be compact and low-cost.

In the drive device having the above first configuration may further include a control circuit (5) configured to permit the switching operation of the switch element to be started only in permission time periods set with a fixed period (a fifth configuration).

The drive device having the above fifth configuration is capable of controlling length of a time period during which the power supply circuit does not perform the switching operation of the switch element, and thus it is possible to prevent the signal processing of the drive-target element from being negatively affected by the switching noise of the power supply circuit.

In the drive device having the above fifth configuration, the control circuit may include a control circuit configured to permit the switching operation of the switch element to be ended both in the permission time periods and in guard-band time periods each set between adjacent ones of the permission time periods (a sixth configuration).

The drive device having the above sixth configuration is capable of suppressing excessive switching operation of the switch element.

In the drive device having the above fifth or sixth configuration, the control circuit may be configured to receive a clock signal with the fixed period, and to set the permission time periods based on the clock signal (a seventh configuration).

The drive device having the above seventh configuration described above is capable of easily setting the permission time periods.

In the drive device having the above seventh configuration, the control circuit may include a latch circuit (FF1) and a plurality of logic gates (AND2, NOT1) (an eighth configuration).

In the drive device having the above eighth configuration, the control circuit can have a simple circuit configuration.

The drive device having any one of the above first to eighth configurations may have a first mode in which a step-up operation of the power supply circuit is turned on, and a second mode in which the step-up operation of the power supply circuit is turned off (a ninth configuration).

The drive device having the above ninth configuration is capable of driving the drive-target element strongly in the first mode, and driving the drive-target element weakly in the second mode. Consequently, the drive device having the above ninth configuration is capable of dealing with both a situation where it is suitable to drive the drive-target element strongly and a situation where it is suitable to drive the drive-target element weakly.

In the drive device having the above ninth configuration, the drive circuit may be configured to intermittently performs repetition of the pulse driving, the first mode may be executed if a period of the repetition is equal to or longer than a threshold value and the second mode may be executed if the period of the repetition is shorter than the threshold value (a tenth configuration).

The drive device having the above tenth configuration is capable of driving the drive-target element strongly and periodically with low frequency in the first mode, and driving the drive-target element weakly and periodically with high frequency in the second mode. Consequently, the drive device having the above tenth configuration is capable of dealing with both a situation where it is suitable to drive the drive-target element strongly and periodically with low frequency and a situation where it is suitable to drive the drive-target element weakly and periodically with high frequency.

An ultrasonic sensor (13, 14) described above includes a piezoelectric element (PZ1) and the drive device having any one of the above first to tenth configurations and configured to drive the piezoelectric element (an eleventh configuration).

The ultrasonic sensor having the above eleventh configuration described above is capable of preventing the signal processing of the drive-target element from being negatively affected by the switching noise of the power supply circuit.

What is claimed is:

1. A drive device, comprising:
a power supply circuit that includes a switch element; and
a drive circuit that is configured to use a voltage supplied from the power supply circuit as a power supply voltage and that is configured to perform pulse driving of a drive-target element,
wherein
the power supply circuit is configured to operate such that a switching frequency of the switch element differs from a frequency of the pulse driving.

2. The drive device according to claim 1,
wherein
the power supply circuit is a charge pump circuit that includes a flying capacitor, and
the power supply circuit is configured to operate such that the pulse driving is started after discharge of the flying capacitor is started, and such that the discharge of the flying capacitor is ended after the pulse driving is ended.

3. The drive device according to claim 2,
wherein
a length of a first time period from start to end of the discharge of the flying capacitor is equal to or longer than a length of a second time period from start to end of the pulse driving but equal to or shorter than two times the length of the second time period.

4. The drive device according to claim 2,
wherein
the power supply circuit does not include a smoothing circuit in an output stage of the power supply circuit.

5. The drive device according to claim 1, further comprising:
a control circuit configured to permit a switching operation of the switch element to be started only in permission time periods set with a fixed period.

6. The drive device according to claim 5,
wherein
the control circuit includes a control circuit configured to permit the switching operation of the switch element to be ended both in the permission time periods and in guard-band time periods each set between adjacent ones of the permission time periods.

7. The drive device according to claim 5,
wherein
the control circuit is configured to receive a clock signal with the fixed period and to set the permission time periods based on the clock signal.

8. The drive device according to claim 7,
wherein
the control circuit includes a latch circuit and a plurality of logic gates.

9. The drive device according to claim 1,
wherein
the drive device has a first mode in which a step-up operation of the power supply circuit is turned on, and a second mode in which the step-up operation of the power supply circuit is turned off.

10. The drive device according to claim 9,
wherein
the drive circuit is configured to intermittently performs repetition of the pulse driving,
the first mode is executed when a period of the repetition is equal to or longer than a threshold value, and
the second mode is executed when the period of the repetition is shorter than the threshold value.

11. An ultrasonic sensor, comprising:
a piezoelectric element; and
the drive device according to claim 1 configured to drive the piezoelectric element.
